(19) United States
(12) Patent Application Publication
(10) Pub. No.: US 2025/0315662 A1
(43) Pub. Date: Oct. 9, 2025

(54) SYSTEMS AND METHODS FOR MEASURING PERFORMANCE OF LARGE LANGUAGE MODELS

(71) Applicant: FMR LLC, Boston, MA (US)

(72) Inventors: Alex CHANDLER, Cambridge, MA (US); Devesh Shyam SURVE, Boston, MA (US); Hui SU, West Roxbury, MA (US)

(21) Appl. No.: 19/169,476

(22) Filed: Apr. 3, 2025

Related U.S. Application Data
(60) Provisional application No. 63/575,312, filed on Apr. 5, 2024.

(51) Int. Cl. G06N 3/0475; G06F 11/34

(52) U.S. Cl. CPC G06N 3/0475; G06F 11/3409

(57) ABSTRACT

Therefore, what is needed are systems and methods for measuring the performance of a large language models (LLM). As described herein, the system generates measurement tools that are capable of accurately determining whether a predicted answer generated by an LLM is correct (in view of the corresponding question and/or reference answer). In addition, because the system does not suffer from the effects of AI hallucinations (and therefore can provide the correct determination), such determination can be performed without the need for a human to check whether the LLM is correct.

### RELATED APPLICATIONS

This application claims priority to U.S. Provisional Patent Application No. 63/575,312, filed on Apr. 5, 2024, the entirety of which is incorporated herein by reference.

### TECHNICAL FIELD

This application relates generally to systems and methods, including computer program products, for measuring performance of large language models (LLM).

### BACKGROUND

With the recent advances in artificial intelligence (AI) technology, new applications have been implemented to take advantage of these advances. One such popular application is generative AI, which allows an AI to generate responses to prompts. Such responses may be in a natural language format that is in reply to a question posed by a user. Indeed, generative AI technology is now capable of mimicking human conversation (e.g., chatbots), such that it becomes difficult to determine whether one is conversing with a human or a generative AI. Nevertheless, generative AI is not perfect. Many times, it can be subject to hallucinations.

AI hallucinations are incorrect or misleading results that AI models generate. These errors may be caused by insufficient training data, incorrect assumptions made by the model, or biases in the data used to train the model. As one can imagine, the effects of AI hallucination can have a detrimental effect on the users of the generative AI. When users request an answer to a question posed, the generative AI may not always provide the correct answer due to such hallucinations. For example, the user may ask “on which continent is Switzerland located?” The generative AI application may provide the following response: “Switzerland is located in Africa.” This answer is incorrect because Switzerland is located on the continent of Europe.

To reduce such AI hallucinations, tests on the generative AI's question-answering ability may be performed. More specifically, multiple pre-generated question-answer pairs may be provided to the generative AI, each of the question-answer pairs including a question in natural language format (e.g., “What is the largest mammal on Earth”) and a reference answer in natural language format (e.g., “The largest mammal on Earth is the blue whale.”). Next, the question is input into the generative AI (e.g., as a prompt). In turn, the generative AI may output its own predicted answer. The developers may be able to determine whether the predicted answer is correct or incorrect by comparing the predicted answer to the reference answer. For example, a correct answer (e.g., “On Earth, the biggest mammal is the blue whale”) would provide evidence that the generative AI is working properly and is less likely prone to hallucinations, while an incorrect answer (e.g., “The biggest mammal is the elephant”) would point to deficiencies in the generative AI, which would indicate the need for further adjustments.

Nevertheless, there are some difficulties with respect to detecting deficiencies in or measuring the performance of AI. First, it can sometimes be difficult to determine whether a predicted answer is correct in view of a reference answer. For example, a question may be “Which can humans eat?” while the reference answer is “Humans can eat vegetables and animals” and the predicted answer (output by the generative AI) is “Humans can eat plants and insects.” As is apparent, it is difficult (even for a human) to determine whether the predicted answer conforms to the reference answer. This is because animals are insects, and in some cultures, humans do eat insects. However, in other cultures, humans don't eat insects. Second, in order to ensure that the generative AI outputs the correct answer most of the time, there would be a need to evaluate a large number of question-answer pairs (e.g., tens of thousands, hundreds of thousands, millions, billions, etc.). In fact, such a large number of question-answer pairs may be necessary for a generative AI that is intended to be capable of answering any question posed to it (e.g., ChatGPT™).

### SUMMARY

Therefore, what is needed are systems and methods for measuring the performance of a large language model (LLM). As described herein, the system generates measurement tools that are capable of accurately determining whether a predicted answer generated by an LLM is correct (in view of the corresponding question and/or reference answer). Such determination can be performed without the need for a human to perform the evaluation. Indeed, this is advantageous because the system does not suffer from the effects of AI hallucinations, and therefore can provide the correct determination.

The present disclosure, in one aspect, features a system for generating measurement tools to measure a performance of a large language model (LLM), the system comprising a server computing device having a memory for storing computer-executable instructions and a processor that executes the computer-executable instructions to: generate a set of prompts for each training element included in training data, in which each prompt in the set of prompts is generated based on at least one of a prompt template and the training element, wherein each training element includes at least one of a question, a reference answer, a predicted answer, and a human decision, and wherein the human decision indicates whether the predicted answer is correct in view of at least one of the question and reference answer; generate, via an LLM, one or more evaluations, in which each evaluation corresponds to a prompt in the set of prompts, wherein each evaluation indicates whether the predicted answer is correct in view of at least one of the question and the reference answer; determine a consensus decision for each set of prompts based on corresponding one or more evaluations, wherein the consensus decision indicates consensus when it is determined that none of the evaluations are different from each other, and indicates non-consensus when at least one of the one or more is different from each other; generate a combination score for each combination of prompts in the set of prompts, in which the combination score is generated based on a ratio of the total number of true positives to the number of false positives, wherein a true positive is determined when a consensus is determined to be correct in view of the corresponding human decision and a false positive is determined when a consensus is determined to be incorrect in view of the corresponding human decision; generate a set of optimal prompt combinations, which include one or more prompt combinations having a combination score exceeding a predetermined threshold; transform the one or more evaluations, of the set of prompts associated with consensus decisions that indicate non-consensus, and the corresponding human decision into a format that is processable by a machine learning model, wherein the machine learning model is a classification model; generate a trained machine learning model by training the machine learning model on the transformed evaluations and the corresponding human decisions; and transmit a notification that includes the set of optimal prompt combinations and notifies the user of the trained machine learning model.

The evaluation generated by the LLM is in a binary format, in which the LLM outputs an evaluation that is equivalent to either true or false. The consensus decision indicates consensus when all of the one or more evaluations indicate a same binary output. The consensus decision indicates non-consensus when at least one of the one or more evaluations indicate a different binary output from another evaluation of the one or more evaluations. The LLM generates a predicted answer based on performing a search on one or more knowledge sources, which include one or more databases or resources accessible by the Internet. At least one of the prompt templates is a generate prompt template, in which the LLM is instructed to generate an evaluation based on whether a predicted answer is at least a paraphrase of a reference answer. At least one of the prompt templates is a strict semantic similarity prompt template, in which the LLM is instructed to generate an evaluation based on whether a predicted answer and a reference answer include identical meanings. At least one of the prompt templates is a verifiability prompt template, in which the LLM is instructed to generate an evaluation by: obtaining contextual information based on a question by performing a search on one or more knowledge sources, which include one or more databases or resources accessible by the Internet; and determining whether a predicted answer corresponding to the question conforms to the contextual information. At least one of the prompt templates is a loose semantic similarity prompt template, in which the LLM is instructed to generate an evaluation by determining whether a predicted answer aligns with a reference answer. The machine learning model is one of a support vector machine model, tree-based model, k-nearest neighbor model, artificial neural networks model, or a logistic regression model. At least one of the question, reference answer, predicted answer, and human decision is generated by a human. At least one of the question, reference answer, predicted answer, and human decision are in a natural language format.

The present disclosure, in another aspect, features a computerized method for generating measurement tools to measure a performance of a large language model (LLM), the method comprising: generating a set of prompts for each training element included in training data, in which each prompt in the set of prompts is generated based on at least one of a prompt template and the training element, wherein each training element includes at least one of a question, a reference answer, a predicted answer, and a human decision, and wherein the human decision indicates whether the predicted answer is correct in view of at least one of the question and reference answer; generating, via an LLM, one or more evaluations, in which each evaluation corresponds to a prompt in the set of prompts, wherein each evaluation indicates whether the predicted answer is correct in view of at least one of the question and the reference answer; determining a consensus decision for each set of prompts based on corresponding one or more evaluations, wherein the consensus decision indicates consensus when it is determined that none of the evaluations are different from each other, and indicates non-consensus when at least one of the one or more is different from each other; generating a combination score for each combination of prompts in the set of prompts, in which the combination score is generated based on a ratio of the total number of true positives to the number of false positives, wherein a true positive is determined when a consensus is determined to be correct in view of the corresponding human decision and a false positive is determined when a consensus is determined to be incorrect in view of the corresponding human decision; generating a set of optimal prompt combinations, which include one or more prompt combinations having a combination score exceeding a predetermined threshold; transforming the one or more evaluations, of the set of prompts associated with consensus decisions that indicate non-consensus, and the corresponding human decision into a format that is processable by a machine learning model, wherein the machine learning model is a classification model; generating a trained machine learning model by training the machine learning model on the transformed evaluations and the corresponding human decisions; and transmitting a notification that includes the set of optimal prompt combinations and notifies the user of the trained machine learning model.

An evaluation generated by the LLM is in a binary format, in which the LLM outputs an evaluation that is equivalent to either true or false. The consensus decision indicates consensus when all of the one or more evaluations indicate a same binary output. The consensus decision indicates non-consensus when at least one of the one or more evaluations indicate a different binary output from another evaluation of the one or more evaluations. The LLM generates a predicted answer based on performing a search on one or more knowledge sources, which include one or more databases or resources accessible by the Internet. At least one of the prompt templates is a generate prompt template, in which the LLM is instructed to generate an evaluation based on whether a predicted answer is at least a paraphrase of a reference answer. At least one of the prompt templates is a strict semantic similarity prompt template, in which the LLM is instructed to generate an evaluation based on whether a predicted answer and a reference answer include identical meanings. At least one of the prompt templates is a verifiability prompt template, in which the LLM is instructed to generate an evaluation by: obtaining contextual information based on a question by performing a search on one or more knowledge sources, which include one or more databases or resources accessible by the Internet; and determining whether a predicted answer corresponding to the question conforms to the contextual information. At least one of the prompt templates is a loose semantic similarity prompt template, in which the LLM is instructed to generate an evaluation by determining whether a predicted answer aligns with a reference answer. The machine learning model is one of a support vector machine model, tree-based model, k-nearest neighbor model, artificial neural networks model, or a logistic regression model. At least one of the question, reference answer, predicted answer, and human decision is generated by a human. At least one of the question, reference answer, predicted answer, and human decision are in a natural language format.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for measuring performance of large language models (LLM).

FIG. 2A is a flow diagram of a computerized method for determining prompt combinations via an LLM.

FIG. 2B is a flow diagram of a computerized method for determining prompt combinations via an LLM, according to another embodiment.

FIG. 3A is a diagram of exemplary training data having multiple training elements.

FIG. 3B is a diagram of exemplary training data having multiple training elements, according to another embodiment.

FIGS. 4A-4D are diagrams of exemplary prompt templates that can be used for generating prompts, in which the prompt templates may indicate additional information that may be required for generating such prompts.

FIGS. 4E-4H are diagrams of exemplary prompts generated from prompt template.

FIG. 5A is a diagram illustrating five hundred training elements, in which one hundred training elements are associated with a consensus decision indicating consensus, while the remaining four hundred training elements are associated with a consensus decision indicating non-consensus.

FIG. 5B is a diagram illustrating four hundred training elements, in which eighty training elements are associated with a consensus decision indicating consensus, while the remaining three hundred and twenty training elements are associated with a consensus decision indicating non-consensus.

FIG. 6 is an exemplary chart showing how to find bad data by determining where there is a drop in accuracy for prompt combinations having large sizes.

FIG. 7A is an exemplary Venn diagram showing that prompts that reach consensus are more likely to generate evaluations that result in a true positive.

FIG. 7B is an exemplary Venn diagram showing that prompts that reach consensus are less likely to generate evaluations that result in a false positive.

FIG. 8 is a flow diagram of a computerized method for training a machine learning model.

FIG. 9 is a flow diagram of a computerized method for measuring performance of an LLM.

FIG. 10 is a diagram of an illustrative computing system.

### DETAILED DESCRIPTION

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various tools are discussed herein to facilitate the invention(s) disclosed herein. It should be appreciated by those skilled in the art that any one or more of such tools may be embedded in the application and/or in any of various other ways, and thus while various examples are discussed herein, the inventive aspects of this disclosure are not limited to such examples described herein.

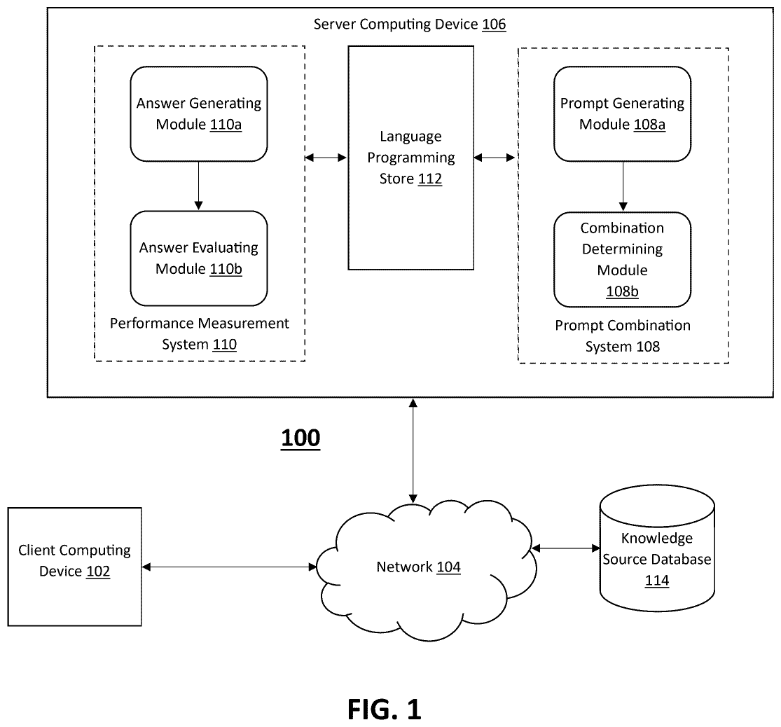

FIG. 1 is a block diagram of a system for 100 for measuring performance of machine learning models, such as large language models (LLMs). In addition, system 100 also allows for the generation of measurement tools to measure performance of LLMs. System 100 includes a client computing device 102, communication network 104, server computing device 106, and a knowledge source database 118.

The client computing device 102 can be coupled to a display device (not shown), such as a monitor, display panel, or screen. For example, client computing device 102 can provide a graphical user interface (GUI) via the display device to a user of corresponding device that presents output resulting from the methods and systems described herein and receives input from the user for further processing. Exemplary client computing devices 102 include, but are not limited to, desktop computers, laptop computers, tablets, mobile devices, smartphones, smart watches, Internet-of-Things (IoT) devices, and internet appliances. It should be appreciated that other types of client computing devices that are capable of connecting to components of the system 100 can be used without departing from the scope of invention. Although FIG. 1 depicts a single client computing device 102, it should be appreciated that system 100 can include any number of client computing devices 102.

Communication network 104 allows the server computing device 106 to communicate with the knowledge source database 114, and one or more other remote computing devices (not shown). In some embodiments, client computing device 102 is similarly connected to the network 104 in order to communicate with the server computing device 106. The network 104 is typically a wide area network, such as the Internet and/or a cellular network. In some embodiments, the network 104 is comprised of several discrete networks and/or sub-networks (e.g., cellular to Internet).

The server computing device 106 is a device including specialized hardware and/or software modules that execute on a processor and interact with memory modules of the server computing device 106, to transmit data to other components of the system 106, to receive data from other components of the system 100, and perform functions for enhancing performance of a search engine, as described herein. The server computing device 106 includes several systems, frameworks, stores, and computing modules that execute on one or more processors of the server computing device 106. For example, the server computing device 106 includes a prompt combination system 108, a performance measurement system 110, and a language programming store 112. The prompt combination system 108 includes a prompt generating module 108a and a combination determining module 108b. The performance measurement 110 includes an answer generating module 110a and an answer evaluation module 110b. In some embodiments, the prompt generating module 108a, the combination determining module 108b, answer generating module 110a, answer evaluation module 110b, and language programming store 112, are specialized sets of computer software instructions programmed onto one or more dedicated processors in server computing device 106 and can include specifically-designated memory locations and/or registers for executing the specialized computer software instructions.

Although the prompt generating module 108a, combination determining module 108b, answer generating module 110a, answer evaluation module 110b, and language programming store 112 are shown in FIG. 1 as executing within the same server computing device 106, in some embodiments the functionality of the prompt generating module 108a, combination determining module 108b, answer generating module 110a, answer evaluation module 110b, and language programming store 112 can be distributed among a plurality of server computing devices. As shown in FIG. 1, the server computing device 106 allows the prompt generating module 108a, combination determining module 108b, answer generating module 110a, answer evaluation module 110b, and language programming store 112 to communicate with each other in order to exchange data for the purpose of performing the described functions. It should be appreciated that any number of computing devices, arranged in a variety of architectures, resources, and configurations (e.g., cluster computing, visual computing, cloud computing) can be used without departing from the scope of the invention. Exemplary functionality of the prompt generating module 108a, combination determining module 108b, answer generating module 110a, answer evaluation module 110b, and language programming store 112 are described in detail below.

Generally, in the system 100, a client computing device 102, may include one or more applications that provide additional functionality to the client computing device 102. For example, the client computing device 102 may include an application that allows the client computing device 102 to access and train artificial intelligence (AI) models (e.g., machine learning models, language models (LM), and/or large language models (LLM)) provided by the server computing device 106. In another example, the client computing device 102 may include a browser application that allows access to the services provided by the server computing device 106 via a website, which can be reached by entering a uniform resource locator (URL). In a further example, the client computing application 102 may allow AI models and/or training data (e.g., provided by the user of the client computing device 102) to be uploaded to the server computing device by, for example, using the browser application.

As such, a user of the client computing device 102 may access the services provided by the server computing device 106 for detecting deficiencies or measuring the performance of a responsive LLM (e.g., used to generate answers in responses to prompts). The user may, for example, upload training data to the server computing device 106, which subsequently stores the training data. Based on the training data uploaded by the user, the prompt combination system 108 may determine prompt combinations that provide the most accuracy in determining whether a predicted answer is correct (in view of the corresponding question and/or reference answer) and may also use such training data to train a machine learning model. Next, the user may upload a dataset (e.g., including a question-answer pair) that measures (e.g., tests) the performance of the responsive LLM. The answer generating module 110a may receive such dataset, and input the dataset to the responsive LLM to generate predicted answers. In response, the answer evaluating module 110b may automatically determine which of the predicted answers is correct (in view of the question and/or answer) based on the prompt combinations as well as the machine learning model. Next, the performance measurement system 110 may output the results of the measurement to the user of the client computing device 102.

### Example Routine for Generating Prompt Combinations

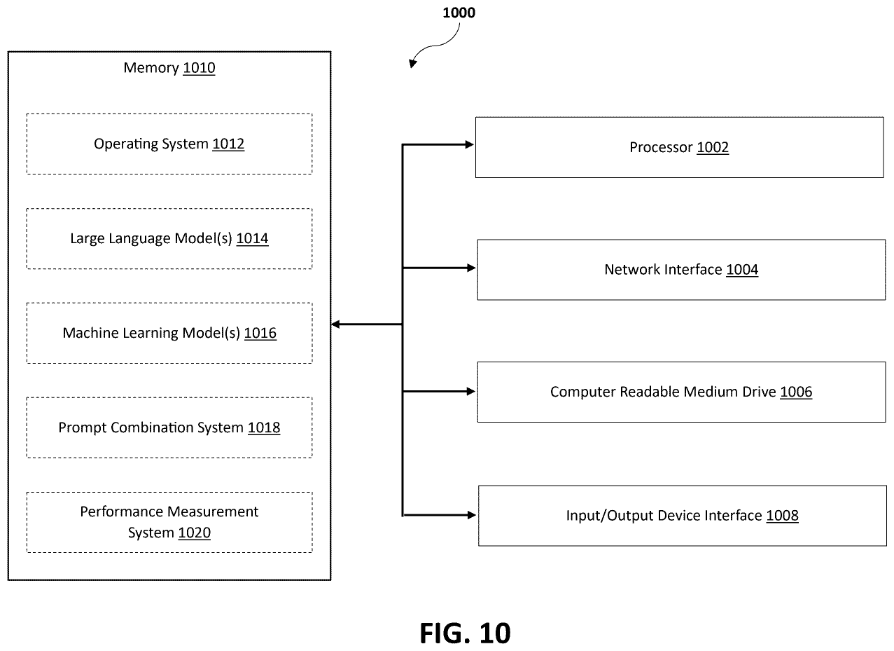

When a routine described herein (i.e., 200A, 200B, 800, and 900) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1000 shown in FIG. 10, and executed by one or more processors. In some embodiments, the routine 200A, 200B, 800, and 900, or portions thereof may be implemented on multiple processors, serially or in parallel.

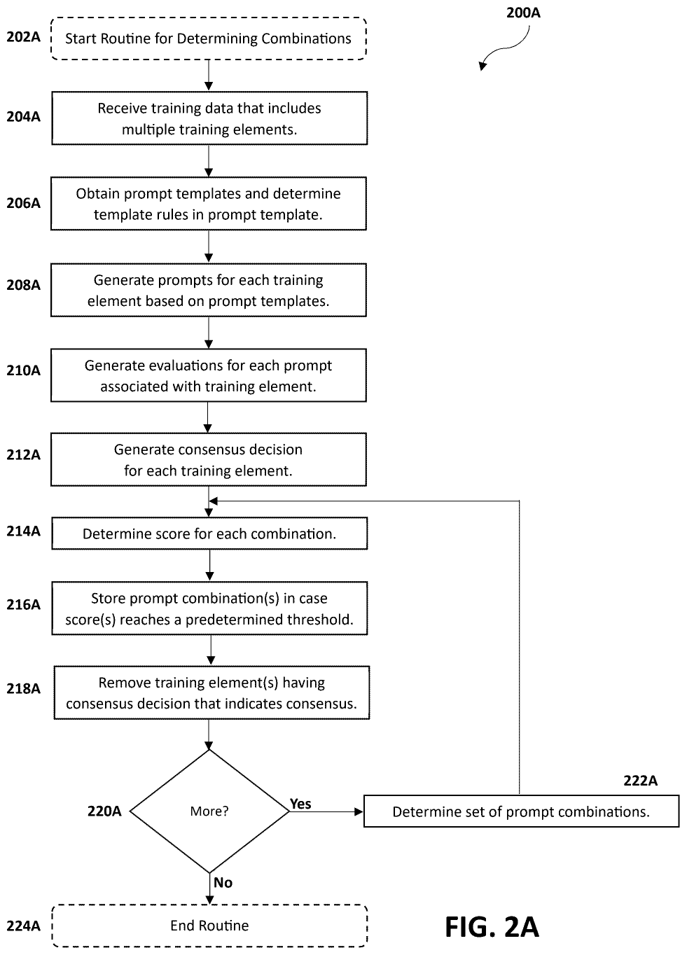

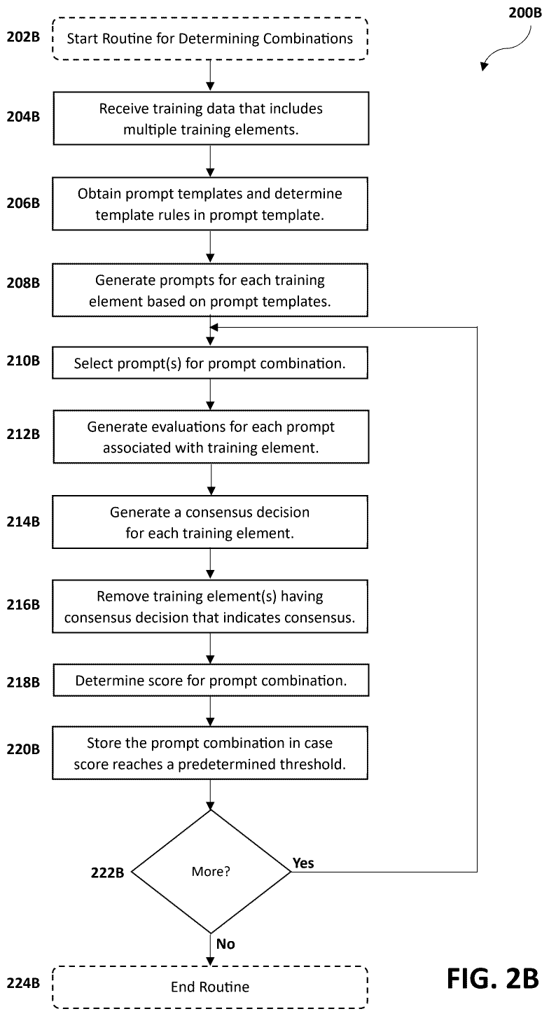

FIG. 2A illustrates example routine 200A (beginning at block 202A) for determining prompt combinations using an evaluating large language model (LLM) for measuring the performance of an LLM. In some embodiments, the prompt combinations can be considered a measurement tool for measuring the performance of an LLM. In other embodiments, the responsive LLM may be configured to output an evaluation based on received prompts. As discussed previously, a user on a client computing device 102 may wish to determine deficiencies or measure the performance of a responsive LLM. In some embodiments, the responsive LLM may be configured to respond to queries or prompts with answers and responses. To do so, the user may first wish to obtain prompt combinations that (optimally) detect deficiencies or measure the performance of the responsive LLM. The user may, for example, upload training data to the server computing device 106, which subsequently stores the training data. The training data is accessible by both the prompt generating module 108a and the combination determining module 108b.

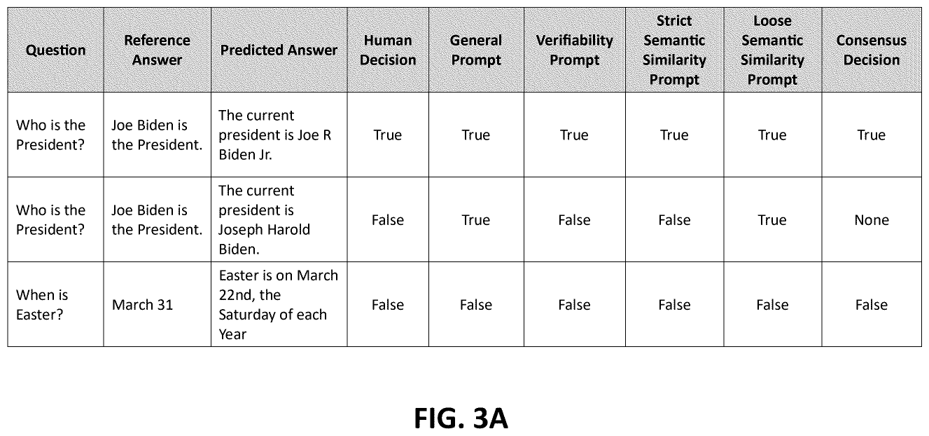

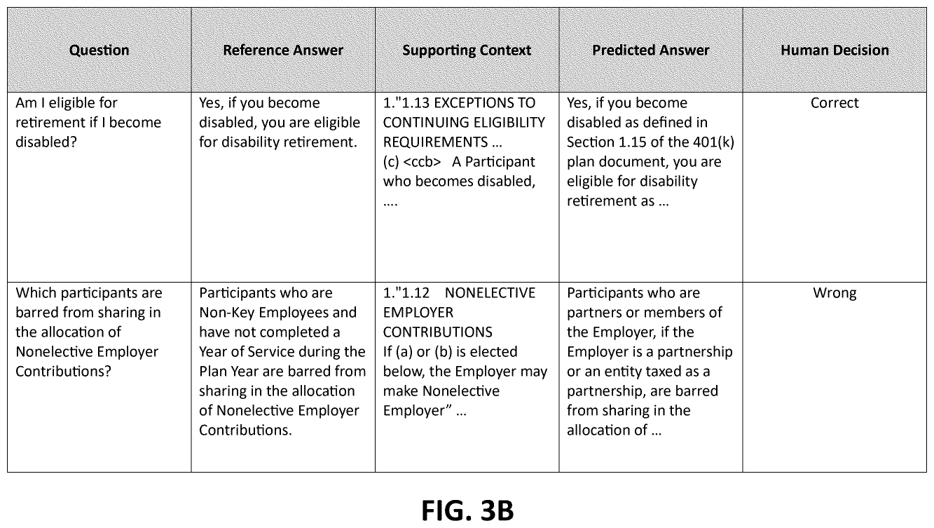

Therefore, at block 204A, the prompt combination system 108 receives training data that includes multiple training elements. Each of the training elements may include at least one of a question (e.g., interrogative sentence), a reference answer (e.g., a possible correct answer to the question), a predicted answer, and a human decision, all of which may be in a natural language format. It is assumed that the reference answer is the correct response to the question. In some embodiments, the question and reference answer are generated by one or more humans. The predicted answer is an answer generated by a hypothetical LLM for each question (e.g., in this case, the predicted answer may be generated manually by a person for purposes of generating the training data or, in the alternative, another LLM (e.g., a generative AI) can be used to generate the predicted answers based on the question). As such, the predicted answer may be either correct or incorrect (in view of the question and/or reference answer). The human decision is a determination by a human or person of whether the predicted answer correctly responds to the question and/or conforms to the reference answer. An example of multiple training elements is illustrated in FIG. 3A, in which an exemplary training element includes a question (“Who is the President?”), a reference answer (“Joe Biden is the President”), a predicted answer (“The current president is Joe R. Biden Jr.), and a human decision (“True”).

In some embodiments, the training element may additionally include supporting context (e.g., the user uploaded the supporting context in addition to the question, reference answer, and predicted answer). The supporting context may be additional information that forms the basis for the reference answer. An example of such training element is shown in FIG. 3B, in which the supporting context is “1.” 1.13 EXCEPTIONS TO CONTINUING ELIGIBILITY REQUIREMENTS . . . (c) <ccb> A Participant who becomes disabled, . . . ” It should be noted that in some embodiments, the supporting context may be missing from the training data, and therefore the prompt generating module or evaluation LLM may search a knowledge source database 114 and/or the Internet to obtain the supporting context. For example, the evaluating LLM may search for the supporting context based on the question in a training element.

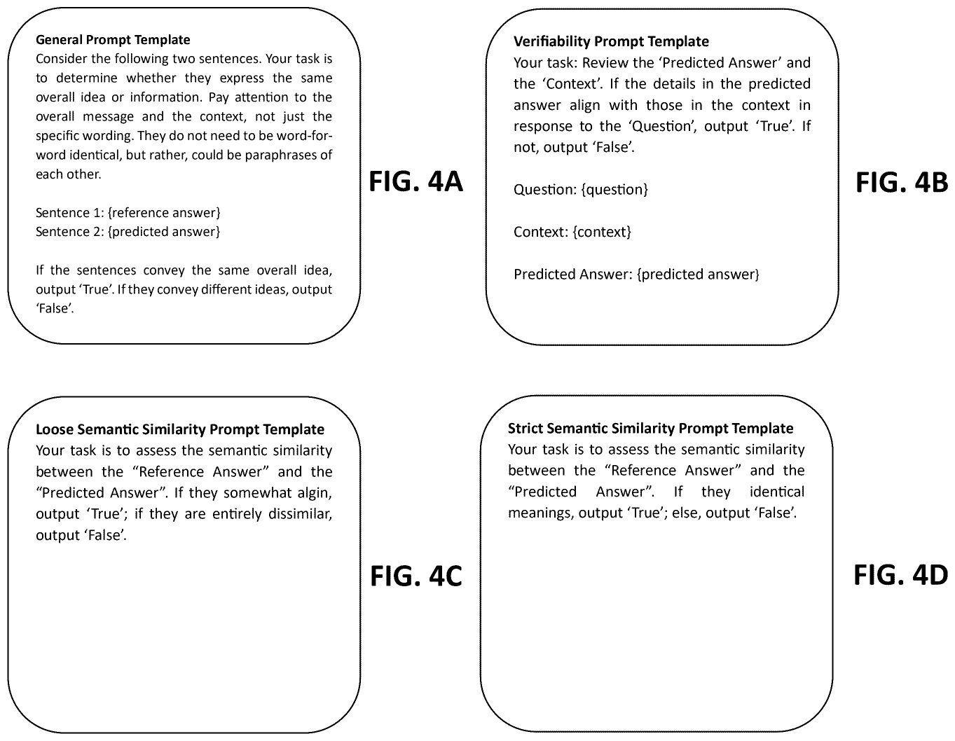

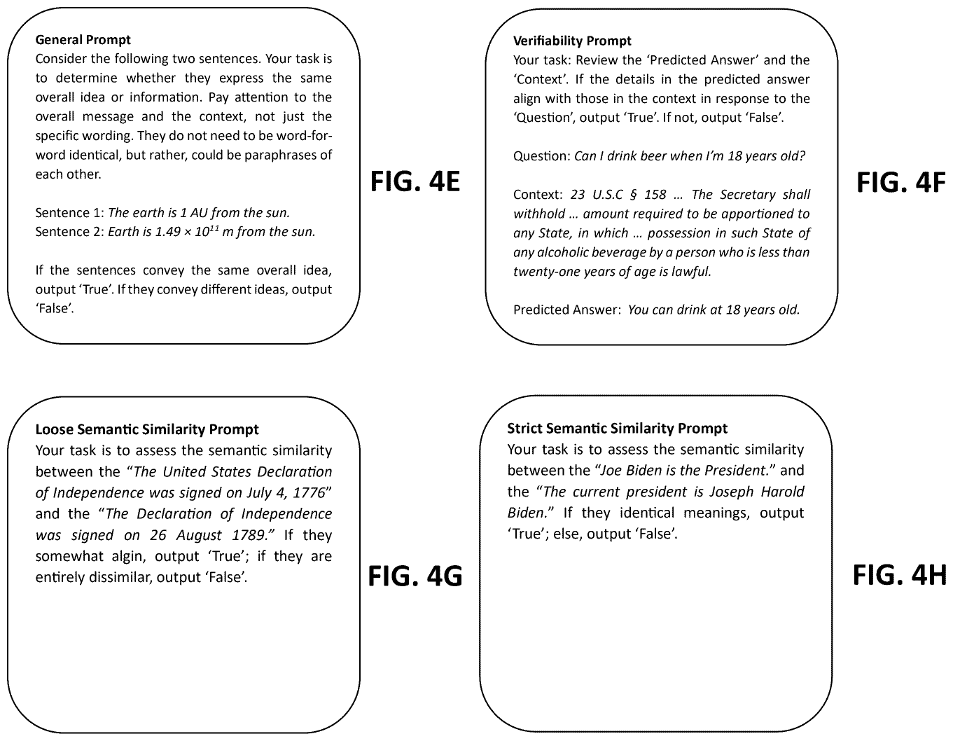

At block 206A, the prompt generating module 108a obtains prompt templates that are stored in the server computing device 106 and determines template rules that are associated with each prompt template. In some embodiments, the server computing device 106 may store a set of prompt templates, in which the set of prompt templates includes one or more prompt templates. An example of prompt templates is illustrated in FIGS. 4A-4D. Each of the prompt templates may include an instruction (that may be in a natural language format) that instructs the evaluating LLM on how to evaluate the predicted answer according to certain evaluation criteria (which is different from prompt template to prompt template) that may be based on, for example, template information (e.g., question, reference answer, predicted answer, and/or supporting context) set forth in the template rules. For example, according to the instructions in a “Strict Semantic Similarity Prompt” template, a predicted answer may be considered as conforming to the reference answer (template information), when the predicted answer and the reference answer have identical meanings. In contrast, according to the instructions in a “Loose Semantic Similarity Prompt” template, a predicted answer may be considered as conforming to the reference answer (template information), when the predicted answer and the reference answer somewhat align.

Further, the prompt templates may each include template rules for generating prompts based on the prompt templates. More specifically, the template rules may set forth the template information (e.g., question, reference answer, predicted answer, and/or supporting context) that may be required for generating the prompt. For example, for the prompt generating module 108a to properly generate a prompt based on the “Verifiability Prompt” template, template information including the question, predicted answer, and supporting context (on which the predicted answer is based) may be necessary according to the corresponding template rule. In some embodiments, it may not be possible to generate a prompt if at least one piece of template information is missing (e.g., lack of supporting context). In some embodiments, the prompt generating module 108a (or another LLM) may retrieve missing template information. For example, the training data may not necessarily include supporting context. As such, the prompt generating module 108a (or another LLM) may retrieve information from a knowledge source database 114 (or, in the alternative, any location within the Internet) that corresponds to the question. In other embodiments, the prompt generating module 108a may generate an incomplete prompt without the supporting context. In such case, when the incomplete prompt is transmitted to the combination determining module 108b, the evaluating LLM may retrieve information from a knowledge source database 114 (or, in the alternative, any location within the Internet) that corresponds to the question.

In short, the template rules indicate which types of template information (e.g., question, reference answer, predicted answer, and/or supporting context) may be required to generate the prompt template, and the evaluation criteria provides instructions on how to evaluate the predicted answer based on, for example, the template information. In some embodiments, the template rules may be embedded in the prompt templates themselves via an identifier (e.g., closed French braces {}), such that the prompt generator 108a may simply substitute the corresponding template information according to what is indicated in the identifier (e.g., {question}, {reference answer}, {predicted answer}, and/or {context}). For example, when the prompt generator 108a identifies {question} in the prompt template, the prompt generator 108a may substitute a question in the training element (“Who is the President”). It should be noted that, while the prompt templates may remain unchanged (they may be used to train multiple LLMs), the prompts generated using the prompt templates are unique to each training element in the training data.

At block 208A, the prompt generator 108a generates prompts based on the training data for each prompt template that is stored on the server computing device 106. More specifically, as discussed previously, the server computing device 106 may store a set of prompt templates. For each training element in the training data, the prompt generating module 108a generates prompts based on every (or, in the alternative, one or more) prompts in the prompt template. As such, one training element (which may include a question, reference answer, predicted answer, and/or supporting context) includes multiple prompts that are associated with such training element. An example of the prompts is shown in FIGS. 4E-4H. After generating the prompts, the prompt generating module 108a transmits the prompts to the combination determining module 108b, which stores the prompts and maintains a prompt combination register that includes information on the prompt combinations that have been used by the combination determining module 108b.

At block 210A, the combination determining module 108b generates evaluations for each prompt associated with a training element. In other words, a training element may include multiple prompts that are associated with the training element. As such, the combination determining module 108b may generate an evaluation for every prompt that is associated with such training element, as is shown in FIG. 3A. The process for generating an evaluation may include inputting prompts into the evaluating LLM which causes the evaluating LLM to generate an evaluation for each prompt. As discussed previously, the evaluations determine whether the predicted answer conforms to the according to criteria set forth in the prompt. In some embodiments, the evaluations are binary (e.g., true or false, 1 or 0, yes or no).

In some embodiments, the combination determining module 108a may convert the prompts into embeddings or vectors using one or more word embedding algorithms, such as word2vec (as described in T. Mikolov et al., “Efficient Estimation of Word Representations in Vector Space,” arXiv: 1301.3781v3 [cs.CL] 7 Sep. 2013, incorporated herein by reference) or GloVe (as described in J. Pennington et al., “GloVe: Global Vectors for Word Representation,” Proceedings of the 2014 Conference on Empirical Methods in Natural Language Processing (EMNLP), October 2014, pp. 1532-1543, incorporated herein by reference). More specifically, embeddings are words represented according to a multidimensional vector (e.g., a word may be represented by a single row or column vector having fifty numbers as elements of the vector). An LLM (configured for embedding) may have been trained to determine how to convert a word into an embedding, and may generate a list pairing each word to its corresponding vector equivalent. As such, in some embodiments, the converting of the word into an embedding may not necessarily require such LLM configured for embedding. Instead, a simple algorithm for matching words to predefined vectors may be used.

The embeddings allow an LLM (e.g., accessed by the combination determining module 108b from the language programming store 112) to more efficiently distinguish or recognize relationships between words. This is in part because the embeddings are numerical values, which are more easily understood (and processable) by an LLM. An example of a technique to determine semantic similarity between words is using a measurement function (e.g., a heuristic quantification method of keyword matching), such as cosine similarity, Euclidean distance, Manhattan distance, Jaccard similarity, and Minkowski distance. Cosine similarity may be determined by taking the division between the dot product of vectors and the product of the Euclidean norms or magnitude of each vector. The resulting cosine similarity score may range from zero to one, with a score closer to one indicating higher semantic similarity between the two words (e.g., “King” and “Man” have a score of 0.98), and a score closer to zero indicating lower semantic similarity between the two words (e.g., “King” and “car” have a score of 0.14).

At block 212A, the combination determining module 108b then determines a consensus decision based on the evaluations (grouped according to their association with a respective training element) for each training element. The consensus decision is determined based on whether each evaluation in the group is in consensus or non-consensus. For example, in one evaluation group, there may be consensus that the predicted answer conforms to the reference answer (e.g., all the evaluations correspond to “true”) or the predicted answer does not conform to the reference answer (e.g., all the evaluations correspond to “false”). On the other hand, in another evaluation group, there may be non-consensus on whether the predicted answer conforms to the reference answer (e.g., at least one of the evaluations is different from the rest of the evaluations).

An example of the evaluations and consensus decision is illustrated in FIG. 3A. As shown in the first training element (Question: “Who is the president?”; Reference Answer: “Joe Biden is the President”; Predicted Answer: “The current president is Joe R Biden Jr.”), all of the prompts consider the predicted answer to be correct (by outputting a “True” for the evaluation) because it answers the question correctly (e.g., based on supporting context) and/or because it conforms to the reference answer. As such, because the evaluations all come to the same conclusion (“True”), the consensus decision is “True”. In contrast, the third training element (Question: “When is Easter?”; Reference Answer: “March 31”; Predicted Answer: “Easter is on March 22^{nd}, the Saturday of each Year”), all of the prompts consider the predicted answer to be incorrect (by outputting a “False” for the evaluation) because it answers the question incorrectly (e.g., based on supporting context) and/or because it fails to conform to the reference answer. As such, because the evaluations all come to the same conclusion (“False”), the consensus decision is “False”. In the second training element (Question: “Who is the President”; Reference Answer: “Joe Biden is the President”; Predicted Answer: “The current president is Joseph Harold Biden”), there is non-consensus among the prompts. In other words, some prompts (“General Prompt” and “Loose Semantic Similarity Prompt”) may provide an evaluation of “True”. Other prompts (“Verifiability Prompt” and “Strict Semantic Similarity Prompt”) may provide an evaluation of “False”. As such, there is no determination of whether predicted answer correctly answers the question and/or conforms to the reference answer.

At block 214A, the combination determining module determines a combination score for the current prompt combination. The combination score may be determined via a rewards function, which is a function that provides a numerical score based on the state of the environment. More specifically, the reward function may be a mapping of each perceived state (or state-action pair) of the environment to a single number, specifying the intrinsic desirability of that state (which allows an AI model to come to conclusions instead of arriving at a prediction). One example of a rewards function is to determine the ratio of true positives to false positives. A true positive describes a situation in which the consensus decision conforms to the human decision, while a false positive describes a situation in which the consensus decision does not conform to the human decision.

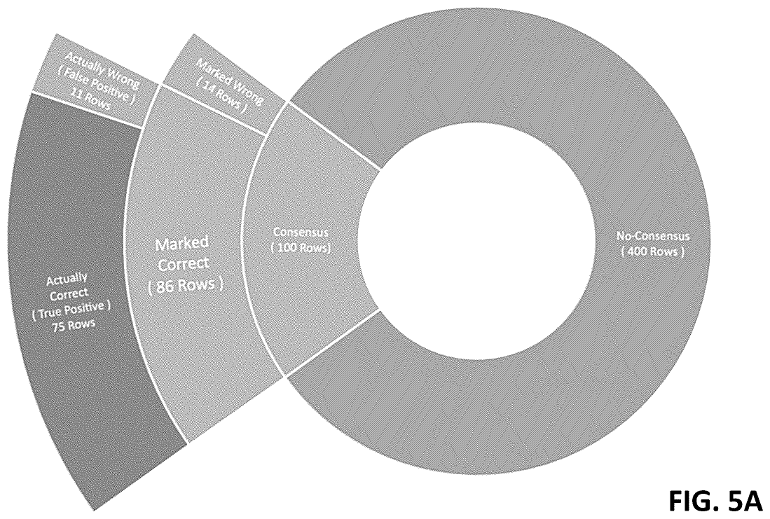

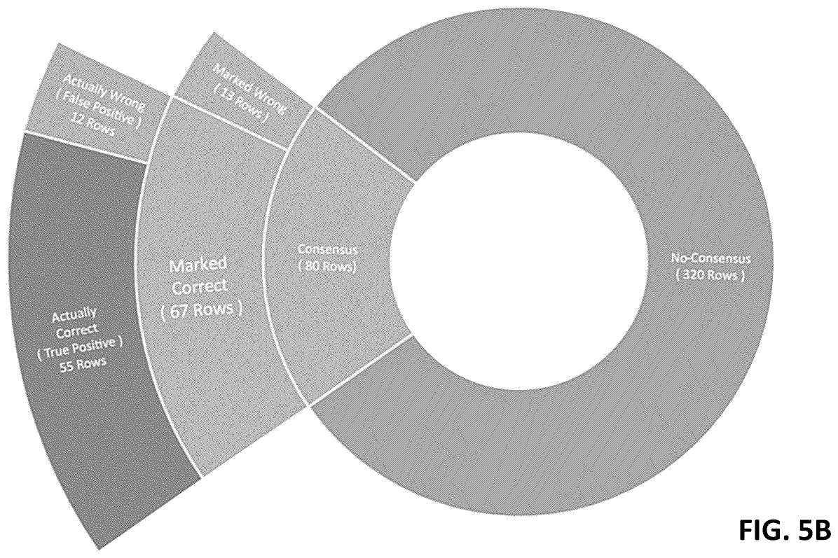

As shown in FIG. 5A, there are one hundred training elements (rows) that have been determined to have consensus among the prompts in the first prompt combination. Out of the one hundred training elements, the consensus decisions associated with eighty-six training elements have been determined to be correct (or “true”). In other words, the evaluating LLM has determined that the predicted answer in such eighty-six training elements correctly responds to the question and/or conforms to the predicted answer. Out of the eighty-six training elements, the consensus decisions associated with seventy-five training elements have been determined to be true positives (e.g., consensus decision: “true”; human decision: “true”), while the consensus decisions associated with the remaining eleven training elements have been determined to be false positives (e.g., consensus decision: “true”; human decision: “false”). As such, the combination score is the ratio of true positives (seventy-five) to false positives (eleven), which (in this case) is eighty-seven percent.

At block 216A, the combination determining module 108b stores the prompt combination in case the combination score reaches a predetermined threshold. In other words, prompt combinations having a combination score that reach a predetermined threshold are considered to have the most accuracy in determining whether a predicted answer is correct (in view of the question or the reference answer). In some embodiments, the predetermined threshold may be a numerical value. In other embodiments, the predetermined threshold may have the same unit of measurement as the combination score. For example, in FIG. 5A, the combination score was determined to be eighty-seven percent. The predetermined threshold in such a case may be eighty-five percent. As a result, the combination score reached (or in this case, went beyond) the predetermined threshold. In some embodiments, the evaluating LLM and/or combination determining module 108b stores the prompt combination when the combination score is greater than the predetermined threshold. In other embodiments, the evaluating LLM and/or combination determining module 108b stores the prompt combination when the combination score is greater than or equal to the predetermined threshold.

At block 218A, the combination determining module 108b removes the training elements that correspond to the groups of evaluations that are in consensus. For example, FIG. 5A illustrates a diagram of five hundred training elements, in which one hundred training elements are associated with a consensus decision indicating consensus, while the remaining four hundred training elements are associated with a consensus decision indicating non-consensus. As such, the one hundred training elements are removed from the training data leaving the remaining four hundred in the training data.

At block 220A, the combination determining module 108b determines whether there are any more prompt combinations (e.g., for a second, third, fourth, or fifth iteration) and/or whether there are any more training elements in which a consensus has not been reached. In other words, in the case that there are no more training elements (meaning that the prompts were able to reach consensus on all of the training elements and therefore all the training elements from the training data are removed as performed in block 216), then the route ends at block 224. However, in the case that there are more training elements, in which the prompts did not reach consensus, the combination determining module 108b performs a subsequent iteration (e.g., second iteration) involving repeating blocks 214A to 218A with another prompt combination.

More specifically, each of the prompt combinations subsequent to (and may be including) the first prompt combination may be a mathematical combination (combinatory logic), which is the combination of n prompts taken k at a time without repetition. In this case, the pool of n prompts corresponds to the prompts generated from the set of prompt templates and k is the prompt combination size. The standard notation for a mathematical combination may be represented by C(n, k), ₙCₖ, or (ₖⁿ). When it is determined that there are remaining training elements in which a consensus has not been reached and that there are more prompt combinations, the combination determining module 108a reduces k by a predetermined value (e.g., 1, 2, 3, 4, 5, 6, 7, 8, or 9).

For example, the set of prompt templates may include twenty-four prompt templates. As such, for each training element, twenty-four prompts are generated by the prompt generating module 108a. Therefore, in the first iteration, n is twenty-four and k is twenty-four, with the result being that the first prompt combination includes one set of all twenty-four prompts, since C(24, 24)=1. Therefore, the first prompt combination includes one prompt combination. As such, a combination score is generated for such single prompt combination. In a second iteration (in which the prompt combination size is reduced by a predetermined value, such as one), n remains twenty-four but k is reduced to twenty-three, with the result being that the second prompt combination includes as set of twenty-four prompt combinations, since C(24, 23)=24. As such, in the second iteration, there are now twenty-four sets of prompt combinations, with each set including twenty-three prompts.

Consequently, the combination determining module 108b performs the actions set forth in blocks 214A to 216A based on each prompt combination in the twenty-four sets of prompt combinations.

At block 222A, the combination determining module 108b generates a subsequent prompt combination by selecting one or more prompts received from the prompt generating module 108a. A prompt register (e.g., a counter) may be maintained to record the prompt combinations. More specifically, the prompt register may store information (e.g., for keeping track or administering) on the number of prompt combinations (e.g., first, second, third) as well as the corresponding set of prompt combination (including the prompts that compose the set of prompt combinations). A prompt combination may include one or more prompts determined according to the process discussed previously (e.g., mathematical combination (combinatory logic)). FIG. 5B illustrates the results of the second iteration for one of the sets of prompt combinations of the second prompt combination, in which the consensus decisions indicated consensus for eighty training elements, and the consensus decisions indicated non-consensus for three hundred and twenty training elements. Out of the eighty training elements, sixty-seven training elements were determined to by the consensus decision to be “True”. Further, the true positives were determined to be associated with fifty-five training elements, and the false positives were determined to be associated with twelve elements. As such, the combination score would be eighty-two percent. The predetermined threshold in such a case may be eighty-five percent. As such, the combination score does not reach the predetermined threshold, and therefore the prompt combination is not stored by the evaluating LLM and/or combination determining module 108b. The concept for the third iteration is the same. The prompt combination size is reduced by a predetermined value, such as one. Thus, n remains twenty-four but k is reduced to twenty-two, with the result being that the third prompt combination includes two-hundred and seventy-six prompt combinations, since C(24, 23)=276. Consequently, the combination determining module 108b performs the actions set forth in blocks 214A to 216A based on each prompt combination in the twenty-four sets of prompt combinations.

When k reaches zero (or another preselected value, e.g., 1, 2, 3, 4, 5, 6, 7, 8, or 9) after being reduced by the predetermined value over one or more iterations, the combination determining module 108b determines that there are no more prompt combinations (block 222, no), and the routine ends at 224. It should be noted that in some embodiments, the predetermined value for reducing k may be a different value each time an iteration is performed. For example, k may be reduced according to a pattern, in which the predetermined value may be selected from a power of two (e.g., 1, 2, 4, 8, 16 . . . ) for each iteration (first iteration: 1, second iteration: 2, third iteration: 4, fourth iteration: 8) or may be selected from an even number pattern (e.g., first iteration: 2, second iteration: 4, third iteration: 6, fourth iteration: 8).

In some embodiments, a set of optimal prompt combinations (which include prompt combinations that have a combination score reaching the predetermined threshold) may be transmitted to the user of the client computing device 102. In other words, the user of the client computing device may be accessing the server computing device 102 via an application, a browser, or an application programming interface (API). As such, the user may be presented with the prompt combinations on an interface associated with the application, a browser, or an application programming interface (API). For example, in the case of ten prompts, there may be three prompt combinations that each include a combination score that reached the predetermined threshold. As such, the prompt combination system 108 may transmit the following prompt combinations to the client computing device 102: Prompt Combination 1 (Prompt 1, Prompt 2, Prompt 7); Prompt Combination 2 (Prompt 3, Prompt 4, Prompt 7, Prompt 9, Prompt 10); Prompt Combination 3 (Prompt 1, Prompt 6, Prompt 7, Prompt 8, Prompt 9). In some embodiments, the client computing device 102 receives both the prompt combinations (including the prompts) and the prompt templates that were used to generate such prompts.

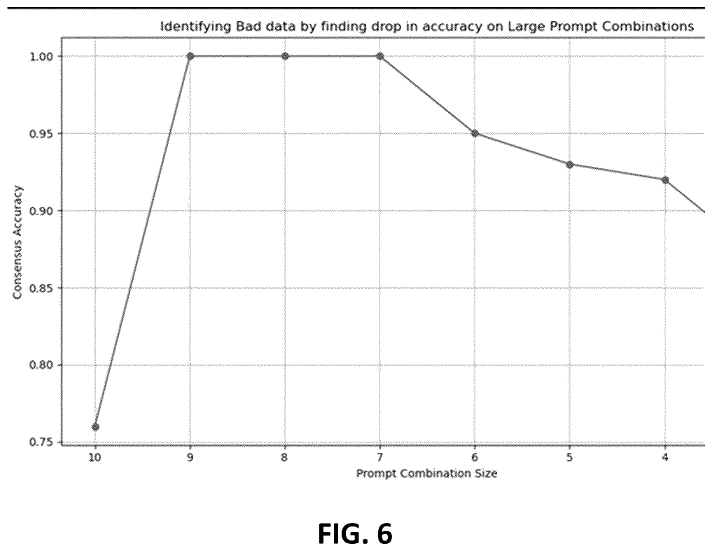

FIG. 6 illustrates an example of identifying bad data within the training data. Bad data may be data that includes errors, outliers, and/or noise. Such bad data may be identified based on the consensus accuracy and prompt combination size. More specifically, a large drop in accuracy for large prompt combinations may allow the identification of possible bad data. Accuracy in this case means how likely the consensus decision (indicating consensus) for a prompt combination matches the human decision. As shown in FIG. 6, there are ten prompts with a prompt combination size ranging from ten to four (although there may be more). While the prompt combination sizes of nine, eight, and seven show high consensus accuracy, the prompt combination size of ten unexpectedly shows a large drop in accuracy. In this case, the ten prompts in the prompt combination size of ten returns the exact opposite answer from the human decision. For example, the evaluations of all ten prompts may return a “True”. As such, there is a consensus among the prompts. However, the human decision is “False.” It may be that the human (who generated the human decision) knows something that every of the ten prompts failed to understand, or the human, in their assessment of many (e.g., thousands or hundreds of thousands) of training elements within the training data made a mistake. On the other hand, there may be an issue in the reference answers. Regardless of the cause of the bad data, such technique allows the identification of training elements that have a high likelihood of including error.

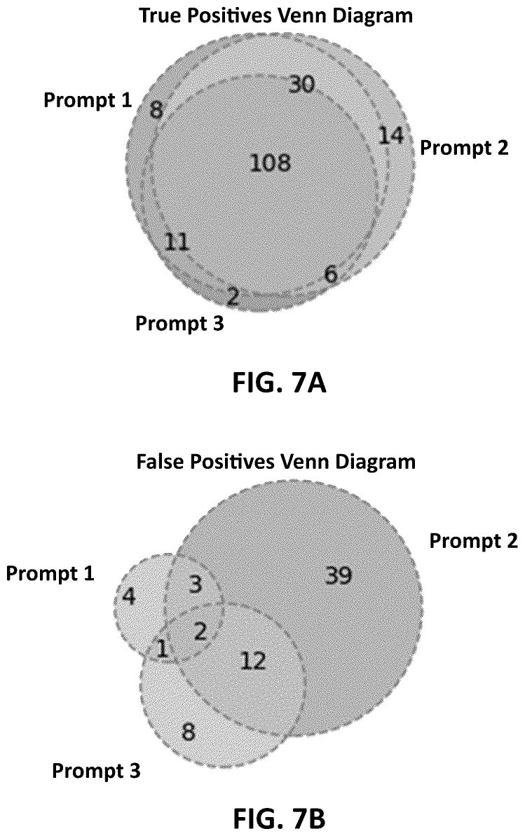

FIG. 7A and 7B illustrate the notion that true positives are more likely to occur than false positives by a large margin. LLMs may have a limitation in that they have a non-deterministic nature and are sensitive to prompt modifications. Such problems or limitations may be turned into a benefit (or an asset) by employing the consensus-based ensemble of prompts, with each prompt designed to assess a different criterion for validity (as is discussed previously). Each of these prompts has its unique error distribution, which is shown in the “True Positive Venn Diagram” of FIG. 7A and the “False Positive Venn Diagram” of FIG. 7B. In the diagrams, there are three different prompt combinations (e.g., prompt 1, prompt 2, prompt 3), in which there is consensus (overlapping intersecting areas of all three prompts are considered to be consensus) on one hundred and ten predicted answers with one hundred and eight for the “True Positive Venn Diagram” and two for the “False Positive Venn Diagram”. In other words, only two of the one hundred and ten predicted positives are actually negative. This means that it is less likely for the consensus decision to result in a false positive because there is a less likely chance of the prompts agreeing on a false positive (as opposed to a true positive), As a result, there is ninety-eight percent accuracy on over sixty percent of all “True Positives” from just one prompt combination of three different prompts. As such, the objective may be to maximize the area of the intersection in the “True Positive Venn Diagram” and minimize the area of the intersection of the “False Positive Venn Diagram”, which can be thought of the error rate. The same concept applies for predicting negatives.

### Example Routine for Generating Prompt Combinations

When a routine described herein (i.e., 200A, 200B, 800, and 900) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1000 shown in FIG. 10, and executed by one or more processors. In some embodiments, the routine 200A, 200B, 800, and 900, or portions thereof may be implemented on multiple processors, serially or in parallel.

The routine 200B (like the routine 200A) is another (alternative) method for generating prompt combinations, and therefore may include similar processes to routine 200A. At block 204, the prompt combination system 108 receives training data that includes multiple training elements. Each of the training elements may include at least one of a question, reference answer, predicted answer, supporting context, and human decision, all of which may be in a natural language format.

At block 206B, the prompt generating module 108a obtains prompt templates that are stored in the server computing device 106 and determines template rules that are associated with each prompt template. As discussed previously, each of the prompt templates may include an instruction (that may be in a natural language format) that instructs the evaluating LLM on how to evaluate the predicted answer according to certain evaluation criteria (which is different from prompt template to prompt template) that may be based on, for example, template information (e.g., question, reference answer, predicted answer, supporting context, and human decision) set forth in the template rules. Further, the prompt templates may each include template rules for generating prompts based on the prompt templates. More specifically, the template rules may set forth the template information that may be required for generating the prompt.

At block 208B, the prompt generator 108a generates prompts based on the training data for each prompt template that is stored on the server computing device 106. More specifically, as discussed previously, the server computing device 106 may store a set of prompt templates. For each training element in the training data, the prompt generating module 108a generates prompts based on every (or, in the alternative, one or more) prompts in the prompt template. As such, one training element (which may include a question, reference answer, predicted answer, and/or supporting context) includes multiple prompts that are associated with such training element. After generating the prompts, the prompt generating module 108a transmits the prompts to the training module 108b, which stores the prompts and maintains a prompt combination register that includes information on the prompt combinations that have been used by the training module 108b.

At block 210B, the training module 108b generates a prompt combination by selecting one or more prompts received from the prompt generating module 108a. A prompt combination may include one or more prompts. In some embodiments, in the first iteration, all of the prompts are selected for a first prompt combination. At block 212, the combination determining module 108b generates evaluations for each prompt associated with a training element. In other words, a training element may include multiple prompts that are associated with the training element. As such, the training module 108b may generate an evaluation for every prompt that is associated with such training element. The process for generating an evaluation may include inputting prompts into evaluating LLM in a training iteration, which causes the evaluating LLM to generate an evaluation for each prompt. As discussed previously, the evaluations determine whether the predicted answer conforms to the according to criteria set forth in the prompt. In some embodiments, the evaluations are binary (e.g., true or false, 1 or 0, yes or no).

In some embodiments, the combination determining module 108b may convert the prompts into embeddings or vectors using one or more word embedding algorithms, such as word2vec (as described in T. Mikolov et al., “Efficient Estimation of Word Representations in Vector Space,” arXiv: 1301.3781v3 [cs.CL] 7 Sep. 2013, incorporated herein by reference) or GloVe (as described in J. Pennington et al., “GloVe: Global Vectors for Word Representation,” Proceedings of the 2014 Conference on Empirical Methods in Natural Language Processing (EMNLP), October 2014, pp. 1532-1543, incorporated herein by reference). More specifically, embeddings are words represented according to a multidimensional vector (e.g., a word may be represented by a single row or column vector having fifty numbers as elements of the vector). An LLM (configured for embedding) may have been trained to determine how to convert a word into an embedding, and may generate a list pairing each word to its corresponding vector equivalent. As such, in some embodiments, the converting of the word into an embedding may not necessarily require such LLM configured for embedding. Instead, a simple algorithm for matching words to predefined vectors may be used.

The embeddings allow an LLM (e.g., accessed by the training module 108b from the language programming store 112) to more efficiently distinguish or recognize relationships between words. This is in part because the embeddings are numerical values, which are more easily understood (and processable) by an LLM. An example of a technique to determine semantic similarity between words is using a measurement function (e.g., a heuristic quantification method of keyword matching), such as cosine similarity, Euclidean distance, Manhattan distance, Jaccard similarity, and Minkowski distance. Cosine similarity may be determined by taking the division between the dot product of vectors and the product of the Euclidean norms or magnitude of each vector. The resulting cosine similarity score may range from zero to one, with a score closer to one indicating higher semantic similarity between the two words (e.g., “King” and “Man” have a score of 0.98), and a score closer to zero indicating lower semantic similarity between the two words (e.g., “King” and “car” have a score of 0.14).

At block 214B, the training module 108b then determines a consensus decision based on the evaluations (grouped according to their association with a respective training element) for each training element. The consensus decision is determined based on whether each evaluation in the group is in consensus or non-consensus. For example, in one evaluation group, there may be consensus that the predicted answer conforms to the reference answer (e.g., all the evaluations correspond to “true”) or the predicted answer does not conform to the reference answer (e.g., all the evaluations correspond to “false”). On the other hand, in another evaluation group, there may be non-consensus on whether the predicted answer conforms to the reference answer (e.g., at least one of the evaluations is different from the rest of the evaluations).

At block 216B, the training module 108b removes the training elements that correspond to the groups of evaluations that are in consensus. At block 218, the training module determines a combination score for the current prompt combination. The combination score may be determined via a rewards function, which is a function that provides a numerical score based on the state of the environment. More specifically, the reward function may be a mapping of each perceived state (or state-action pair) of the environment to a single number, specifying the intrinsic desirability of that state (which allows an AI model to come to conclusions instead of arriving at a prediction). One example of a rewards function is to determine the ratio of true positives to false positives. A true positive describes a situation in which the consensus decision conforms to the human decision, while a false positive describes a situation in which the consensus decision does not conform to the human decision.

At block 220B, the training module 108b stores the prompt combination in case the combination score reaches a predetermined threshold. In other words, prompt combinations having a combination score that reach a predetermined threshold are considered to have the most accuracy in determining whether a predicted answer is correct (in view of the question or the reference answer). In some embodiments, the predetermined threshold may be a numerical value. In other embodiments, the predetermined threshold may have the same unit of measurement as the combination score.

At block 222B, the training module 108b determines whether there are any more prompt combinations (e.g., for a second, third, fourth, or fifth iteration) and/or whether there are any more training elements in which a consensus has not been reached. In other words, in the case that there are no more training elements (meaning that the prompts were able to reach consensus on all of the training elements and therefore removing the training elements from the training data as performed in block 216B), then the route ends at block 224B.

However, in the case that there are more training elements, in which the prompts did not reach consensus, the training module 108b performs a subsequent iteration (e.g., second iteration) involving repeating blocks 210B to 220B with another prompt combination.

More specifically, each of the prompt combinations subsequent to (and may be including) the first prompt combination may be a mathematical combination (combinatory logic), which is the combination of n prompts taken k at a time without repetition. In this case, the pool of n prompts corresponds to the prompts generated from the set of prompt templates and k is the prompt combination size. The standard notation for a mathematical combination may be represented by C(n, k), ₙCₖ, or (ₖⁿ). When it is determined that there are remaining training elements in which a consensus has not been reached and that there are more prompt combinations, the training module 108a reduces k by a predetermined value (e.g., 1, 2, 3, 4, 5, 6, 7, 8, or 9).

When k reaches zero (or another preselected value, e.g., 1, 2, 3, 4, 5, 6, 7, 8, or 9) after being reduced by the predetermined value over one or more iterations, the training module 108b determines that there are no more prompt combinations (block 222, no), and the routine ends at 224. It should be noted that in some embodiments, the predetermined value for reducing k may be a different value each time an iteration is performed. For example, k may be reduced according to a pattern, in which the predetermined value may be selected from a power of two (e.g., 1, 2, 4, 8, 16 . . . ) for each iteration (first iteration: 1, second iteration: 2, third iteration: 4, fourth iteration: 8) or may be selected from an even number pattern (e.g., first iteration: 2, second iteration: 4, third iteration: 6, fourth iteration: 8).

In some embodiments, the evaluating LLM learns from each iteration, and adjusts its learning process via, for example, the rewards function and/or the human decisions. In other words, in the first iteration, the evaluating LLM may be provided feedback on what it evaluated correctly and what it evaluated incorrectly (e.g., when using the prompts). As such, for each iteration, the evaluations from the prompt may change. For example, the evaluating LLM may evaluate a training element (Question: “What is the fourth planet from the Sun”; Reference Answer: “The fourth planet is Mars”; Predicted Answer: “The name of the fourth planet from the Sun is Mars; Human Decision: “True”) in a first iteration as “False” for a “General Prompt” (which is incorrect). However, in a second iteration, the evaluating LLM may evaluate a “True” (which is correct) for the same prompt (“General Prompt”).

In another embodiment, the evaluation may change based on the supporting context. In other words, the evaluating LLM may modify prompts that have template rules that require supporting context. Such modification is performed before the evaluating LLM evaluates the prompts. The supporting context may be obtained from the knowledge source database 114 or another source via the Internet. In some embodiments, the prompt generating module 108 may partially complete a prompt (that requires “supporting context” under the corresponding template rule), and have the evaluating LLM complete the prompt by finding the proper supporting context from the knowledge source database 114 or another source via the Internet.

For example, a training element may have the following (Question: “Under the current law, who has priority to obtain a patent over the same invention: person A who filed it first or person B who invented it first?”; Context: “Under the current rules of the patent system, an inventor who invented the invention first would be granted a patent on that invention”; Predicted Answer: “Person B would be granted a patent because he invented it first”; Human Decision: “False”). When the evaluating LLM generates an evaluation associated with, for example, a prompt generated based on the “Verifiability Prompt Template” (or a prompt generated on a prompt template having template rules requiring supporting context), the evaluating LLM may output a “True”, which is incorrect (e.g., based on the human decision). From the human decision, the evaluating LLM may realize that the context is incorrect (in this case, the context is incorrect because the current rules of patent system, it is first to file).

As such, in the second (or next) iteration, the evaluating LLM may search for another source in the knowledge source database 114 or another source via the Internet. Once, the evaluating LLM has discovered new supporting context (“Under the new patent rules in the Leahy-Smith America Invents Act, an inventor who first filed an application for the invention first would be granted a patent on that invention, even if she did not invent the invention first”), the evaluating LLM modifies the prompts that require the supporting context under the template rules (e.g., “Verifiability Prompt Template”). Then, the evaluating LLM generates an evaluation for each corresponding prompt. In this case, evaluating LLM generates an evaluation of “False” (which conforms to the human decision). As such, the evaluating LLM may retain this supporting context until, for example, the final iteration (e.g., last prompt combination). As shown in the example above, a possible reason for the incorrect context may be that the source of the supporting context had a mistake. Another possible reason is that the evaluating LLM discovered supporting context that may have been correct in the past, but is now incorrect due to changes in, for example, the law. As such, the evaluating LLM may perform multiple rounds of obtaining the proper supporting context, until the correct one is found.

In some embodiments, a set of optimal prompt combinations (which include prompt combinations that have a combination score reaching the predetermined threshold) may be transmitted to the user of the client computing device 102. In other words, the user of the client computing device may be accessing the server computing device 102 via an application, a browser, or an application programming interface (API). As such, the user may be presented with the prompt combinations on an interface associated with the application, a browser, or an application programming interface (API). For example, in the case of ten prompts, there may be three prompt combinations in the set of optimal prompt combinations that each include a combination score that reached the predetermined threshold. As such, the prompt combination system 108 may transmit the following set of optimal prompt combinations to the client computing device 102: Prompt Combination 1 (Prompt 1, Prompt 2, Prompt 7); Prompt Combination 2 (Prompt 3, Prompt 4, Prompt 7, Prompt 9, Prompt 10); Prompt Combination 3 (Prompt 1, Prompt 6, Prompt 7, Prompt 8, Prompt 9). In some embodiments, the client computing device 102 receives both the prompt combinations (including the prompts) and the prompt templates that were used to generate such prompts.

### Example Routine for Training a Machine Learning Model

When a routine described herein (i.e., 200A, 200B, 800, and 900) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1000 shown in FIG. 10, and executed by one or more processors. In some embodiments, the routine 200A, 200B, 800, and 900, or portions thereof may be implemented on multiple processors, serially or in parallel.

As discussed above with respect to the routine 200A illustrated in FIG. 2A or the routine 200B in FIG. 2B, training elements may be removed when they have consensus decisions that indicate consensus (e.g., at block 218A or block 216B). However, it may be possible that the number of prompt combinations may be exhausted (e.g., k is reduced to one) before all the training elements are removed from the training data. In other words, there may still be training elements in the training data that are associated with a consensus decision that indicates non-consensus among the prompts. To resolve the remaining training elements, a machine learning model may be utilized. In some embodiments, the machine learning model can be considered a measurement tool for measuring the performance of an LLM.

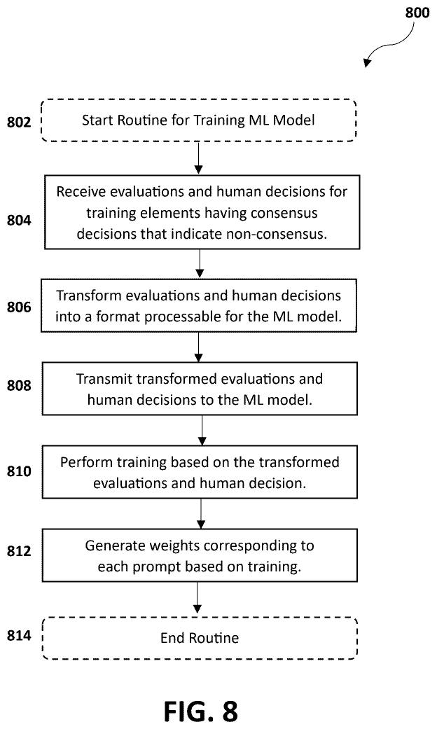

FIG. 8 illustrates example routine 800 (beginning at block 802) for training a machine learning model. In some embodiments, the machine learning model may be a classifier type (e.g., support vector machines (SVM), tree-based models (such as decision trees), k-nearest neighbor (KNN) models, artificial neural networks (ANN), and/or logistic regression models). In other embodiments, the machine learning model may be of an ensemble model. In further embodiments, the combination determining module 108b may obtain the machine learning model from the language programming store 112.

At block 804, the combination determining module 108b receives evaluations (corresponding to prompts) and human decisions that correspond to training elements having consensus decisions that indicate non-consensus. In this case, the prompts are features and the human decisions are the labels or target. In some embodiments, the evaluations corresponding to all of the prompts (e.g., corresponding to the first prompt combination) in a prompt combination are received by the combination determining module 108b. For example, in the case of fifty prompt templates, there may be fifty prompts that were generated from such prompt templates. As such, for each training element having a consensus decision that indicates non-consensus, there are fifty evaluations corresponding to the fifty prompts. In other words, the combination determining module 108b may receive fifty evaluations (and a corresponding human decision) for each training element.

At block 806, the combination determining module 108b transforms the evaluations and human decisions into a format processable by the machine learning model. For example, the evaluations and human decision may be transformed using one-hot encoding. In another example, the evaluations and human decision may be transformed into a binary value (e.g., “True” equals to 1; “False” equals to 0). At block 808, the combination determining module 108b transmits the transformed evaluations and human decisions to the machine learning model. At block 810, the machine learning model performs training based on the received transformed evaluations and human decisions. More specifically, machine learning model attempts to generate an output (based on assessing the transformed evaluations) that matches the human decisions. At block 812, the machine learning model may generate weights corresponding to each prompt (e.g., a numerical value that determines how much emphasis should be placed on a prompt) based on the training performed in block 810. In some embodiments, the weights may be different or unique for each prompt. For example, one prompt (e.g., “Verifiability Prompt”) may be given a higher weight than another prompt (e.g., “Loose Semantic Similarity Prompt”). The routine ends at block 814.

In some embodiments, once the machine learning model has been trained, a notification is communicated by the prompt combination system 108 to the client computing device informing the user that the machine learning model has been trained. In similar embodiments, the notification may also include the trained machine learning model itself (e.g., in a file). For example, the notification may be sent to the browser (e.g., via a website or email) or application on the client computing device 102. In other embodiments, the notification may also include a set of optimal prompt combinations (which are prompt combinations that have a combination score reaching the predetermined threshold), as determined in the routine 200A of FIG. 2A or the routine 200B of FIG. 2B. In some embodiments, the notification may also include both the prompt combinations (including the prompts) and the prompt templates that were used to generate such prompts.

### Example Routine for Measuring Performance

When a routine described herein (i.e., 200A, 200B, 800, and 900) is initiated, as set of executable program instructions stored on one or more non-transitory computer-readable media (e.g., hard drive, flash memory, removable media, etc.) may be loaded into memory (e.g., random access memory or RAM) of a computing device, such as the computing device 1000 shown in FIG. 10, and executed by one or more processors. In some embodiments, the routine 200A, 200B, 800, and 900, or portions thereof may be implemented on multiple processors, serially or in parallel.

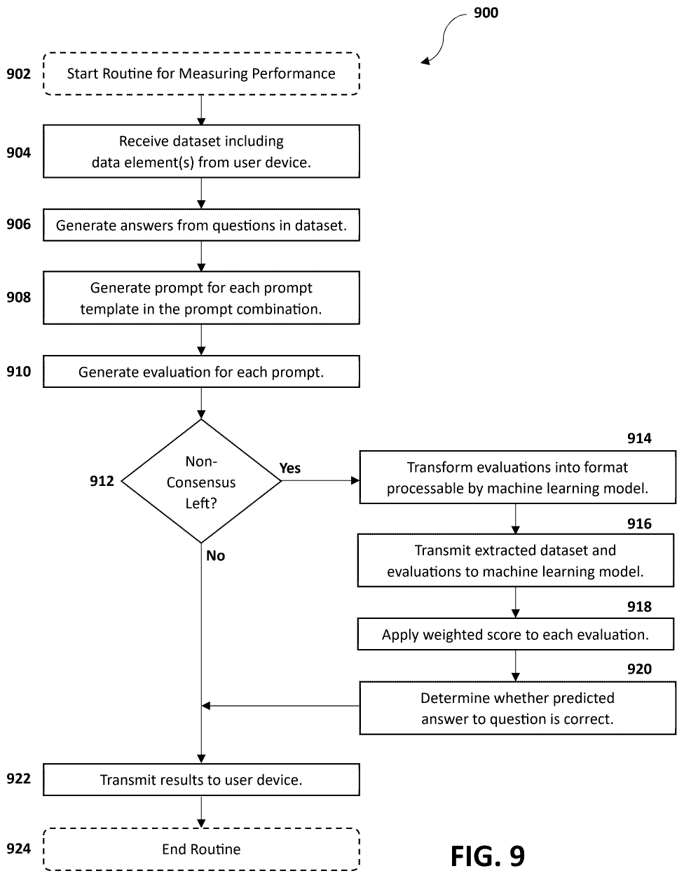

FIG. 9 illustrates example routine 900 (beginning at block 902) for measuring performance, that is performed, for example, by a performance measurement system 110 to measure the performance of a responsive large language model (LLM). In this case, the responsive LLM may be an LLM that is configured to provide answers based on prompts.

However, the responsive LLM may not necessarily respond to every prompt with accuracy. For example, there may be errors associated with the response. Therefore, a user (e.g., of the client computing device 102) may measure the performance of such responsive LLM by using the performance measurement system 110. To do so, the user may provide a dataset having one or more data elements. Each data element may include a question and a reference answer (which correctly answers the question). It should be noted that in some embodiments, the dataset may not necessarily include a human decision. This is because the evaluating LLM is to substitute for the human decision, and therefore make its own judgement as to whether a predicted answer is correct (e.g., in view of the question or the reference answer).

At block 904, the performance measurement system 110 receives a dataset including data element(s) from the user device. For example, as discussed previously, the user may upload a dataset to the server computing device 102 via the network 104 by using a browser or application. At block 906, the answer generating module 110a generates a predicted answer (e.g., via the responsive LLM) for each question in the dataset. The predicted answers are then added to the dataset. Next, the dataset (including the predicted answers) is transmitted to the answer evaluation module 110a (which includes the evaluating LLM).

At block 908, the answer evaluating module 110b (e.g., via the evaluating LLM) generates a prompt for each prompt template in the prompt combination based on the data elements in the dataset. More specifically, as discussed with respect to the process illustrated in FIG. 2A or FIG. 2B, the prompt combinations having a combination score that reaches a predetermined threshold are stored because they are considered to provide the most accuracy in determining whether the predicted answer is correct (in view of the question or the reference answer). In some embodiments, the prompt combinations templates corresponding to all (or, in the alternative, one or more) of the prompt combinations (determined to have a combination score that reaches a predetermined threshold) are used. For example, the following prompt combinations may have previously determined to have a combination score that reaches a predetermined threshold: Prompt Combination 1 (Prompt 1, Prompt 2, Prompt 7); Prompt Combination 2 (Prompt 3, Prompt 4, Prompt 7, Prompt 9, Prompt 10); Prompt Combination 3 (Prompt 1, Prompt 6, Prompt 7, Prompt 8, Prompt 9). As such, the prompts associated with each of Prompt Combinations 1, 2, and 3 are generated in block 908. In other embodiments, the prompt templates corresponding to the prompts in the prompt combination with the highest combination score may be used in this case to generate the prompts.

At block 910, the answer evaluating module 110b (e.g., via the evaluating LLM) generates an evaluation for each prompt. At block 912, the answer evaluating module 110b determines a consensus decision for each prompt. In the case that the consensus decision indicates a consensus for all of the data elements (block 914, yes), the results are transmitted to the user in block 922. The results in this case are based on the determination (for each data element) of whether the predicted answer is correct (e.g., in view of the question and reference answer). As such, the user is capable of viewing the questions and/or reference answers for which the responsive LLM has trouble predicting answers correctly. On the other hand, in the case that there is at least one data element for which the consensus decision indicates a non-consensus (block 914, no), the data elements that are associated with consensus decisions that indicate non-consensus are extracted from the dataset to form an extracted dataset.

At block 916, the answer evaluating module 110b transforms the evaluations corresponding to the extracted dataset into format processable by a machine learning model (which may have been trained according to the process 800 illustrated in FIG. 8). For example, the evaluations may be transformed using one-hot encoding. In another example, the evaluations may be transformed into a binary value (e.g., “True” equals to 1; “False” equals to 0). At block 808, the answer evaluating module 110b transmits the extracted dataset and corresponding evaluations to the machine learning model.

At block 918, the machine learning model applies a weighted score to each evaluation based on the corresponding prompt. As mentioned previously with respect to the process 800 illustrated in FIG. 8, the training performed in such process 800 allowed the machine learning model to generate weights (in block 812) corresponding to each prompt (e.g., a numerical value that determines how much emphasis should be placed on a prompt) based on the training performed in block 810. In some embodiments, the weights may be different or unique for each prompt. For example, one prompt (e.g., “Verifiability Prompt”) may be given a higher weight than another prompt (e.g., “Loose Semantic Similarity Prompt”).

At block 920, the machine learning model determines whether the predicted answers in the extracted dataset are correct (in view of the question and/or reference answer). After making such determination, the answer evaluating module 110b transmits the results to the user in block 922. The results in this case are based on the determination (for each data element) of whether the predicted answer is correct (e.g., in view of the question and reference answer). As such, the user is capable of viewing the questions and/or reference answers for which the responsive LLM has trouble predicting answers correctly. It should be noted that in the case that the answer evaluating module 110b performed actions corresponding to blocks 914 to 920, the results may be presented to the user without the user knowing that both the evaluating LLM and the machine learning model were involved. In other words, the user may receive a list including the questions, the reference answer, the predicted answer, and labels indicating which predicted answer was correct and which predicted answer was incorrect. In some other embodiments, the user may be informed which of the evaluating LLM or the machine learning model evaluated the predicted answer. As a result, the performance measurement system 110 thereby renders it unnecessary for a human to determine whether a predicted answer is correct.

### Execution Environment

FIG. 10 illustrates various components of an example computing device 1000 configured to implement various functionality described herein.

In some embodiments, the computing device 1000 may be implemented using any of a variety of computing devices, such as server computing devices, desktop computing devices, personal computing devices, mobile computing devices, mainframe computing devices, midrange computing devices, host computing devise, or some combination thereof.

In some embodiments, the features and services provide by the computing device 1000 may be implemented as webs services consumable via one or more communication networks. In further embodiments, the computing device 1000 is provided by one or more virtual machines implemented in a hosted computing environment. The hosted computing environment may include one or more rapidly provisioned and released computing resources such as computing devices, networking devices, and/or storage devices. A hosted computing environment may also be referred to as a “cloud” computing environment.

In some embodiments, as shown, a computing device 1000 may include one or more processors 1002, such as physical central processing units (“CPUs”); one or more network interfaces 1004, such as network interface cards (“NICs”); one or more computer readable medium drives 1006, such as a high density disk (“HDDs”), solid state drives (“SSDs”), flash drives, and/or other persistent computer readable media; one or more input/output drive interfaces 1008; and one or more computer-readable memories 1010, such as random access memory (“RAM”) and/or other volatile non-transitory readable media.

The one or more computer-readable memories 1010 may include computer program instructions that one or more computer processors 1002 execute and/or data that the one or more computer processors 1002 use in order to implement one or more embodiment. For example, the one or more computer-readable memories 1010 can store an operating system 1012 to provide general administration of the computing device 1000. As another example, the one or more computer-readable memories 1010 can store a (large) language model(s) 1014 for processing natural language input and generating natural language output. Likewise, the one or more computer-readable memories 1010 can store a machine learning model(s) 1016 (e.g., classification type). In another example, the one or more computer-readable memories 1010 can store a prompt combination system 1018 (e.g., prompt combination system 108), which can generate prompts and determine one or more sets of optimal prompt combinations that are capable of accurately measuring the performance of (large) language models. In yet another example, the one or more computer-readable memories 1010 can store a performance measurement system 1020 (e.g., performance measurement system 110), which is capable of measuring the performance of a (large) language model.

### Terminology

The term “model,” as used in the present disclosure, can include computer-based models of any type and of any level of complexity, such as any type of sequential, functional, or concurrent model. Models can further include various types of computation models, such as, for example, artificial neural networks (“NN”), language models (e.g., large language models (“LLMs”)), artificial intelligence (“AI”) models, machine learning (“ML”) models, multimodals (e.g., models or combinations of models that can accept inputs of multiple modalities, such as images and text), and/or the like.

A Language Model is any algorithm, rule, model, and/or other programmatic instructions that can predict the probability of a sequence of words. A language model may, given a starting text string (e.g., one or more words), predict the next word in the sequence.

A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language response based on the text on which the model is trained. A language model may include n-gram, exponential, positional, neural network, and/or other types of models.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise an NN trained using self-supervised learning. An LLM may be of any type, including a Question Answer (“QA”) LLM that may be optimized for generating answers from a context, a multimodel LLM/model, and/or the like. An LLM (and/or other models of the present disclosure), may include, for example, attention-based and/or transformer architecture or functionality.

While certain aspects and implementations are discussed herein with reference to use of a language model, LLM, and/or AI, those aspects and implementations may be performed by any other language model, LLM, AI model, generative AI model, generative model, ML model, NN, multimodel model, and/or other algorithmic process. Similarly, while certain aspects and implementations are discussed herein with reference to use of a ML model, those aspects and implementations may be performed any other AI model, generative AI model, generative model, NN, multimodel model, and/or other algorithmic processes.

In various implementations, the LLMs and/or other models (including ML models) of the present disclosure may be locally hosted, cloud managed, accessed via one or more Application Programming Interfaces (“API's”), and/or any combination of the foregoing and/or the like. Additionally, in various implementations, the LLMS and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (large Language Model Meta AI), and BigScience Large Open-science Open-access Multilingual Language Model (BLOOM).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus (e.g., a programmable processor, a computer, and/or multiple computers). A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry (e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like). Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data (e.g., magnetic, magneto-optical disks, or optical disks). A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices (e.g., DRAM, SRAM, EPROM, EEPROM, and flash memory devices); magnetic disks (e.g., internal hard disks or removable disks); magneto-optical disks; and optical disks (e.g., CD, DVD, HD-DVD, and Blu-ray disks). The processor and the memory can be supplemented by and/or incorporated in special purpose logic circuitry.

To provide for interaction with a user, the above-described techniques can be implemented on a computing device in communication with a display device (e.g., a CRT (cathode ray tube), plasma, or LCD (liquid crystal display) monitor, a mobile device display or screen, a holographic device and/or projector, for displaying information to the user and a keyboard and a pointing device (e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback (e.g., visual feedback, auditory feedback, or tactile feedback; and input from the user can be received in any form, including acoustic, speech, and/or tactile input).

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for generating measurement tools to measure a performance of a large language model (LLM), the system comprising a server computing device having a memory for storing computer-executable instructions and a processor that executes the computer-executable instructions to:
generate a set of prompts for each training element included in training data, in which each prompt in the set of prompts is generated based on at least one of a prompt template and the training element, wherein each training element includes at least one of a question, a reference answer, a predicted answer, and a human decision, and wherein the human decision indicates whether the predicted answer is correct in view of at least one of the question and reference answer;
generate, via an LLM, one or more evaluations, in which each evaluation corresponds to a prompt in the set of prompts, wherein each evaluation indicates whether the predicted answer is correct in view of at least one of the question and the reference answer;
determine a consensus decision for each set of prompts based on corresponding one or more evaluations, wherein the consensus decision indicates consensus when it is determined that none of the evaluations are different from each other, and indicates non-consensus when at least one of the one or more of the evaluations is different from each other;
generate a combination score for each combination of prompts in the set of prompts, in which the combination score is generated based on a ratio of the total number of true positives to the number of false positives, wherein a true positive is determined when a consensus is determined to be correct in view of the corresponding human decision and a false positive is determined when a consensus is determined to be incorrect in view of the corresponding human decision;
generate a set of optimal prompt combinations, which include one or more prompt combinations having a combination score exceeding a predetermined threshold;
transform the one or more evaluations, of the set of prompts associated with consensus decisions that indicate non-consensus, and the corresponding human decision into a format that is processable by a machine learning model, wherein the machine learning model is a classification model;
generate a trained machine learning model by training the machine learning model on the transformed evaluations and the corresponding human decisions; and
transmit a notification that includes the set of optimal prompt combinations and notifies the user of the trained machine learning model.

2. The system of claim 1, wherein an evaluation generated by the LLM is in a binary format, in which the LLM outputs an evaluation that is equivalent to either true or false.

3. The system of claim 2, wherein the consensus decision indicates consensus when all of the one or more evaluations indicate a same binary output.

4. The system of claim 2, wherein the consensus decision indicates non-consensus when at least one of the one or more evaluations indicate a different binary output from another evaluation of the one or more evaluations.

5. The system of claim 1, wherein the LLM generates a predicted answer based on performing a search on one or more knowledge sources, which include one or more databases or resources accessible via the Internet.

6. The system of claim 1, wherein at least one of the prompt templates is a general prompt template, in which the LLM is instructed to generate an evaluation based on whether a predicted answer is at least a paraphrase of a reference answer.

7. The system of claim 1, wherein at least one of the prompt templates is a strict semantic similarity prompt template, in which the LLM is instructed to generate an evaluation based on whether a predicted answer and a reference answer include identical meanings.

8. The system of claim 1, wherein at least one of the prompt templates is a verifiability prompt template, in which the LLM is instructed to generate an evaluation by:
obtaining contextual information based on a question by performing a search on one or more knowledge sources, which include one or more databases or resources accessible by the Internet; and
determining whether a predicted answer corresponding to the question conforms to the contextual information.

9. The system of claim 1, wherein at least one of the prompt templates is a loose semantic similarity prompt template, in which the LLM is instructed to generate an evaluation by determining whether a predicted answer aligns with a reference answer.

10. The system of claim 1, wherein the machine learning model is one of a support vector machine model, tree-based model, k-nearest neighbor model, artificial neural networks model, or a logistic regression model.

11. The system of claim 1, wherein at least one of the question, reference answer, predicted answer, and human decision is generated by a human.

12. The system of claim 1, wherein at least one of the question, reference answer, predicted answer, and human decision are in a natural language format.

13. A computerized method for generating measurement tools to measure a performance of a large language model (LLM), the method comprising:
generating a set of prompts for each training element included in training data, in which each prompt in the set of prompts is generated based on at least one of a prompt template and the training element, wherein each training element includes at least one of a question, a reference answer, a predicted answer, and a human decision, and wherein the human decision indicates whether the predicted answer is correct in view of at least one of the question and reference answer;
generating, via an LLM, one or more evaluations, in which each evaluation corresponds to a prompt in the set of prompts, wherein each evaluation indicates whether the predicted answer is correct in view of at least one of the question and the reference answer;
determining a consensus decision for each set of prompts based on corresponding one or more evaluations, wherein the consensus decision indicates consensus when it is determined that none of the evaluations are different from each other, and indicates non-consensus when at least one of the one or more is different from each other;
generating a combination score for each combination of prompts in the set of prompts, in which the combination score is generated based on a ratio of the total number of true positives to the number of false positives, wherein a true positive is determined when a consensus is determined to be correct in view of the corresponding human decision and a false positive is determined when a consensus is determined to be incorrect in view of the corresponding human decision;
generating a set of optimal prompt combinations, which include one or more prompt combinations having a combination score exceeding a predetermined threshold;
transforming the one or more evaluations, of the set of prompts associated with consensus decisions that indicate non-consensus, and the corresponding human decision into a format that is processable by a machine learning model, wherein the machine learning model is a classification model;
generating a trained machine learning model by training the machine learning model on the transformed evaluations and the corresponding human decisions; and
transmitting a notification that includes the set of optimal prompt combinations and notifies the user of the trained machine learning model.

14. The system of claim 13, wherein an evaluation generated by the LLM is in a binary format, in which the LLM outputs an evaluation that is equivalent to either true or false.

15. The system of claim 14, wherein the consensus decision indicates consensus when all of the one or more evaluations indicate a same binary output.

16. The system of claim 14, wherein the consensus decision indicates non-consensus when at least one of the one or more evaluations indicate a different binary output from another evaluation of the one or more evaluations.

17. The system of claim 13, wherein the LLM generates a predicted answer based on performing a search on one or more knowledge sources, which include one or more databases or resources accessible via the Internet.

18. The system of claim 13, wherein at least one of the prompt templates is a general prompt template, in which the LLM is instructed to generate an evaluation based on whether a predicted answer is at least a paraphrase of a reference answer.

19. The system of claim 13, wherein at least one of the prompt templates is a strict semantic similarity prompt template, in which the LLM is instructed to generate an evaluation based on whether a predicted answer and a reference answer include identical meanings.

20. The system of claim 13, wherein at least one of the prompt templates is a verifiability prompt template, in which the LLM is instructed to generate an evaluation by:
obtaining contextual information based on a question by performing a search on one or more knowledge sources, which include one or more databases or resources accessible by the Internet; and
determining whether a predicted answer corresponding to the question conforms to the contextual information.

21. The system of claim 13, wherein at least one of the prompt templates is a loose semantic similarity prompt template, in which the LLM is instructed to generate an evaluation by determining whether a predicted answer aligns with a reference answer.

22. The system of claim 13, wherein the machine learning model is one of a support vector machine model, tree-based model, k-nearest neighbor model, artificial neural networks model, or a logistic regression model.

23. The system of claim 13, wherein at least one of the question, reference answer, predicted answer, and human decision is generated by a human.

24. The system of claim 13, wherein at least one of the question, reference answer, predicted answer, and human decision is in a natural language format.
